(19) United States
(12) Patent Application Publication
(10) Pub. No.: US 2024/0347247 A1
(43) Pub. Date: Oct. 17, 2024

(54) INDUCTOR COMPONENT

(71) Applicant: Murata Manufacturing Co., Ltd., Kyoto-fu (JP)

(72) Inventors: Kosuke ISHIDA, Nagaokakyo-shi (JP); Kenichi TANI, Nagaokakyo-shi (JP); Yuuichirou YOSHIDA, Nagaokakyo-shi (JP)

(73) Assignee: Murata Manufacturing Co., Ltd., Kyoto-fu (JP)

(21) Appl. No.: 18/632,853

(22) Filed: Apr. 11, 2024

(30) Foreign Application Priority Data
Apr. 14, 2023 (JP) 2023-066498

(51) Int. Cl. H01F 5/04; H01F 27/29

(52) U.S. Cl. CPC H01F 5/04; H01F 27/292

(57) ABSTRACT

An inductor component includes a base body, a coil inside the base body and helically wound along the axis, and first and second outer electrodes in the base body and electrically connected to the coil. The base body includes first and second end surfaces opposite each other, first and second side surfaces opposite each other, a bottom surface connected between the first and second end surfaces between the first and second side surfaces, and a top surface opposite the bottom surface. The first and second outer electrodes are at least on the bottom surface. The axis is parallel to the bottom surface and intersects with the first and second side surfaces. The coil includes coil wiring layers stacked along the axis, and via wiring layers connecting adjacent ones of the coil wiring layers in an axial direction, which is a direction of the axis.

### CROSS-REFERENCE TO RELATED APPLICATION

This application claims benefit of priority to Japanese Patent Application No. 2023-066498, filed Apr. 14, 2023, the entire content of which is incorporated herein by reference.

### BACKGROUND

### Technical Field:

The present disclosure relates to an inductor component.

### Background Art:

An example of inductor components is disclosed in Japanese Unexamined Patent Application Publication No. 2019-192829. This inductor component includes a base body, a coil disposed inside the base body and helically wound along an axis, and a first outer electrode and a second outer electrode disposed in the base body and electrically connected to the coil. The coil includes a plurality of coil wiring layers stacked along the axis, and a plurality of via wiring layers each configured to connect adjacent ones of the coil wiring layers in a direction of the axis.

### SUMMARY

In recent years, efforts have been made to make inductor components smaller. It was found that during mounting of the inductor component of the related art on a mount board, for example, thermal stress from solder or bending stress from the mount board might cause significant stress on a connecting portion of a via wiring layer and a coil wiring layer and result in the occurrence of delamination between the via wiring layer and the coil wiring layer.

Accordingly, the present disclosure provides an inductor component that can reduce the occurrence of delamination between a via wiring layer and a coil wiring layer.

An inductor component according to an aspect of the present disclosure includes a base body, a coil disposed inside the base body and helically wound along an axis, and a first outer electrode and a second outer electrode disposed in the base body and electrically connected to the coil. The base body includes a first end surface and a second end surface opposite each other, a first side surface and a second side surface opposite each other, a bottom surface connected between the first end surface and the second end surface and between the first side surface and the second side surface, and a top surface opposite the bottom surface. The first outer electrode and the second outer electrode are disposed at least on the bottom surface. The axis is parallel to the bottom surface and intersects with the first side surface and the second side surface. The coil includes a plurality of coil wiring layers stacked along the axis, and a plurality of via wiring layers each configured to connect adjacent ones of the coil wiring layers in an axial direction, which is a direction of the axis. The coil includes a bottom surface facing portion facing the bottom surface, as viewed in the axial direction, without the first outer electrode, the second outer electrode, and the coil therebetween. The bottom surface facing portion does not include the via wiring layer, but includes the coil wiring layer.

In the aspect described above, the bottom surface facing portion of the coil does not include the via wiring layer but includes the coil wiring layer. Therefore, when the inductor component is mounted on a mount board, with the bottom surface of the base body facing the mount board, no via wiring layer is present in the bottom surface facing portion of the coil close to the mount board.

Thus, even when thermal stress or bending stress during mounting causes significant stress on the bottom surface facing portion, the occurrence of delamination between the via wiring layer and the coil wiring layer can be reduced as, the via wiring layers are present outside the bottom surface facing portion of the coil. Accordingly, even in recent circumstances where efforts have been made to make the inductor component smaller, the occurrence of delamination between the via wiring layer and the coil wiring layer can be reduced.

The inductor component according to the aspect of the present disclosure, described above, can reduce the occurrence of delamination between the via wiring layer and the coil wiring layer.

### BRIEF DESCRIPTION OF THE DRAWINGS

FIG. 1 is a perspective view illustrating a first embodiment of an inductor component;

FIG. 2 is a transparent front view of the inductor component, as viewed from a first side surface;

FIG. 3A is an exploded plan view of the inductor component;

FIG. 3B is another exploded plan view of the inductor component;

FIG. 4 is a transparent front view of a second embodiment of the inductor component, as viewed from the first side surface of the inductor component;

FIG. 5 is an exploded plan view of the inductor component;

FIG. 6 is a transparent front view of a third embodiment of the inductor component, as viewed from the first side surface of the inductor component; and

FIG. 7 is a perspective view of the third embodiment of the inductor component.

### DETAILED DESCRIPTION

An inductor component, which is an aspect of the present disclosure, will now be described in detail by illustrated embodiments. Note that the accompanying drawings include schematic representations and do not necessarily reflect actual dimensions or ratios.

### First Embodiment

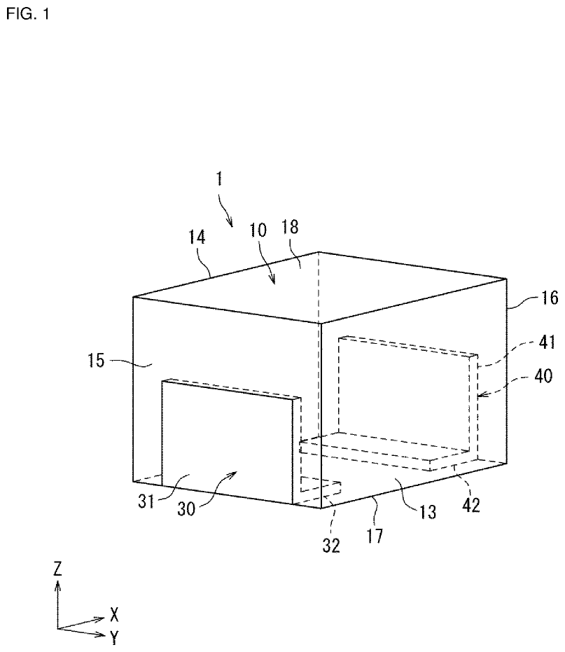

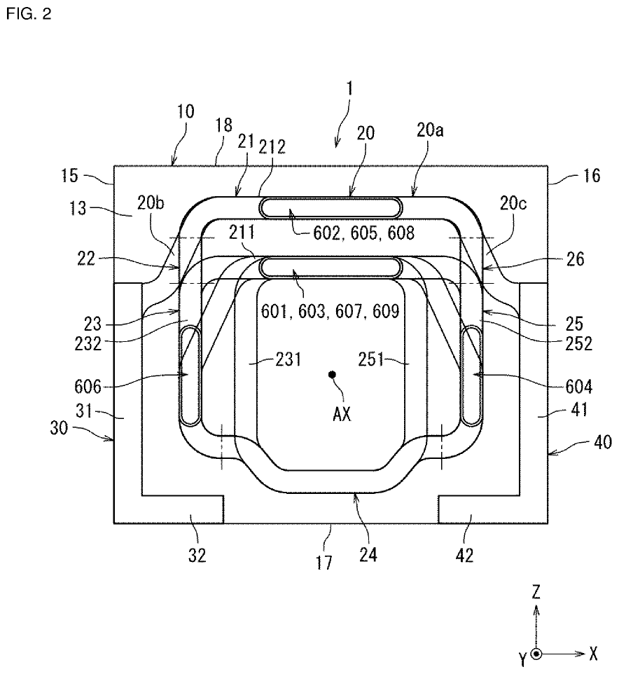

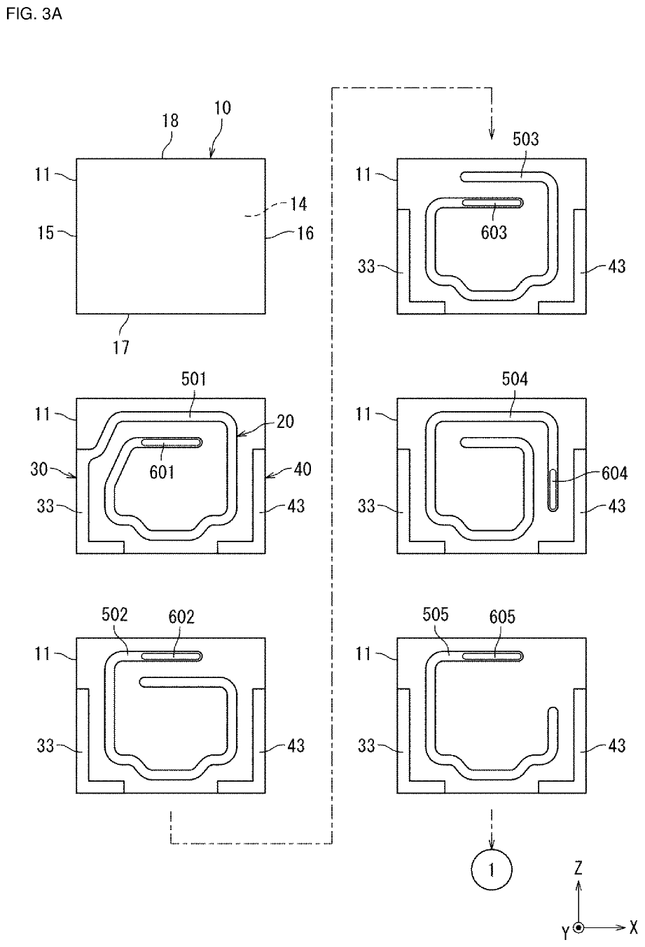

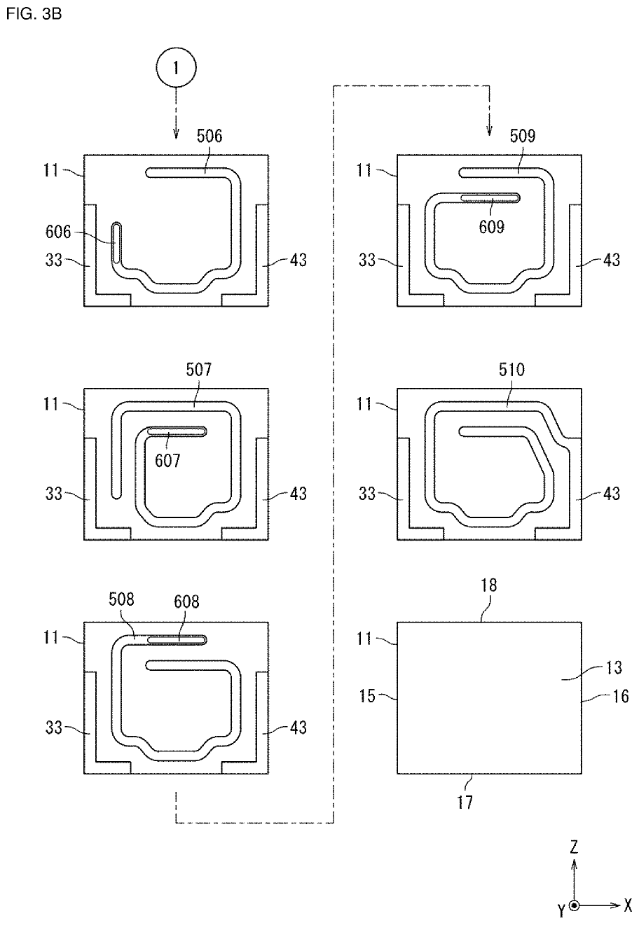

FIG. 1 is a perspective view illustrating a first embodiment of an inductor component. FIG. 2 is a transparent front view of the inductor component, as viewed from a first side surface. FIG. 3A and FIG. 3B are exploded plan views of the inductor component. As illustrated in FIG. 1, FIG. 2, FIG. 3A, and FIG. 3B, an inductor component 1 includes a base body 10, a coil 20 disposed inside the base body 10 and helically wound along an axis AX, and a first outer electrode 30 and a second outer electrode 40 disposed in the base body 10 and electrically connected to the coil 20. The base body and the coil are illustrated as being transparent in FIG. 2 for easy understanding of the structure, but they may be either semitransparent or opaque.

The inductor component 1 is electrically connected at the first and second outer electrodes 30 and 40 to wires on a circuit board (not illustrated). The inductor component 1 is used, for example, as an impedance matching coil (matching coil) of a high-frequency circuit and used in electronic devices, such as personal computers, DVD players, digital cameras, TV sets, mobile phones, car electronics, and medical and industrial machines. Applications of the inductor component 1 are not limited to this. For example, the inductor component 1 may also be used in tuning circuits, filter circuits, and rectifier and smoothing circuits.

The base body 10 is substantially in the shape of a rectangular parallelepiped. The surface of the base body 10 includes a first end surface 15 and a second end surface 16 opposite each other, a first side surface 13 and a second side surface 14 opposite each other, a bottom surface 17 connected between the first end surface 15 and the second end surface 16 and between the first side surface 13 and the second side surface 14, and a top surface 18 opposite the bottom surface 17. The bottom surface 17 is a surface facing a mount board (not illustrated) when the inductor component 1 is mounted on the mount board.

As illustrated, an X direction is a direction orthogonal to the first end surface 15 and the second end surface 16, and is directed from the first end surface 15 toward the second end surface 16. A Y direction is a direction orthogonal to the first side surface 13 and the second side surface 14, and is directed from the second side surface 14 toward the first side surface 13. A Z direction is a direction orthogonal to the bottom surface 17 and the top surface 18, and is directed from the bottom surface 17 toward the top surface 18. The X direction is also referred to as the direction of the length of the base body 10, the Y direction is also referred to as the direction of the width of the base body 10, and the Z direction is also referred to as the direction of the height of the base body 10. The X direction, the Y direction, and the Z direction are directions orthogonal to each other and constitute a left-handed system when arranged in the order of X, Y, and Z.

The base body 10 is formed by stacking a plurality of insulating layers 11. The insulating layers 11 are made of, for example, a material mainly composed of borosilicate glass, or a material such as ferrite or resin. The stacking direction of the insulating layers 11 is a direction (Y direction) parallel to the first and second end surfaces 15 and 16 and the bottom surface 17 of the base body 10. That is, the insulating layers 11 are layers extending in the XZ plane. The term “parallel” in the present application is not limited to an exactly parallel relation, but encompasses a substantially parallel relation when the range of variation in practice is taken into consideration. In the base body 10, the interfaces between the insulating layers 11 may be unclear because of, for example, firing. In FIG. 3A and FIG. 3B, the direction from top to bottom is the stacking direction (Y direction).

The first outer electrode 30 and the second outer electrode 40 are made of a conductive material, such as Ag, Cu, Au, or an alloy mainly composed of any of these materials. The first outer electrode 30 is an L-shaped electrode extending from the first end surface 15 to the bottom surface 17. The first outer electrode 30 is embedded in the base body 10 to be exposed at the first end surface 15 and the bottom surface 17. The first outer electrode 30 has a first end surface portion 31 extending along the first end surface 15, and a first bottom surface portion 32 connected to the first end surface portion 31 and extending along the bottom surface 17.

The second outer electrode 40 is an L-shaped electrode extending from the second end surface 16 to the bottom surface 17. The second outer electrode 40 is embedded in the base body 10 to be exposed at the second end surface 16 and bottom surface 17. The second outer electrode 40 has a second end surface portion 41 extending along the second end surface 16, and a second bottom surface portion 42 connected to the second end surface portion 41 and extending along the bottom surface 17.

The first outer electrode 30 has a structure formed by stacking a plurality of first outer electrode conductor layers 33 embedded in the base body 10 (insulating layers 11). The second outer electrode 40 has a structure formed by stacking a plurality of second outer electrode conductor layers 43 embedded in the base body 10 (insulating layers 11). The first outer electrode conductor layers 33 extend along the first end surface 15 and the bottom surface 17, and the second outer electrode conductor layers 43 extend along the second end surface 16 and the bottom surface 17.

The first and second outer electrodes 30 and 40 can thus be embedded in the base body 10. This can make the inductor component smaller than with a structure where outer electrodes are external to the base body 10. Also, since the coil 20 and the outer electrodes 30 and 40 can be produced in the same process, variation in positional relation between the coil 20 and the outer electrodes 30 and 40 can be reduced. This can reduce variation in the electrical characteristics of the inductor component 1.

The first outer electrode 30 may be constituted by the first bottom surface portion 32 without the first end surface portion 31. Similarly, the second outer electrode 40 may be constituted by the second bottom surface portion 42 without the second end surface portion 41. That is, the first outer electrode 30 and the second outer electrode 40 are simply required to be disposed at least on the bottom surface 17 of the base body 10.

For example, the coil 20 is made of a conductive material similar to, or the same as, that used to make the first and second outer electrodes 30 and 40. The coil 20 is helically wound along the stacking direction of the insulating layers 11. The coil 20 is connected at a first end thereof to the first outer electrode 30, and connected at a second end thereof to the second outer electrode 40. In the present embodiment, the coil 20 and the first and second outer electrodes 30 and 40 are integrated and there are no clear boundaries between them. However, the configuration is not limited to this. The coil and the outer electrodes may be made of different materials or produced by different techniques; that is, there may be boundaries between them.

The coil 20 is wound along the axis AX such that the axis AX is parallel to the bottom surface 17 and that the axis AX intersects with the first side surface 13 and the second side surface 14. The axis AX of the coil 20 coincides with the stacking direction of the insulating layers 11 (Y direction). The axis AX of the coil 20 refers to the central axis of the helical shape of the coil 20. Specifically, the axis AX refers to the center of the innermost circumference of the coil 20.

The coil 20 has a wound portion 20a, a first extended portion 20b connected between a first end of the wound portion 20a and the first outer electrode 30, and a second extended portion 20c connected between a second end of the wound portion 20a and the second outer electrode 40. In the present embodiment, the wound portion 20a and the first and second extended portions 20b and 20c are integrated and there are no clear boundaries between them. However, the configuration is not limited to this. The wound portion and the extended portions may be made of different materials or produced by different techniques; that is, there may be boundaries between them.

The wound portion 20a is helically wound along the axis AX. That is, the wound portion 20a refers to a helically wound portion where different parts of the coil 20 coincide, as viewed in a direction parallel to the axis AX. The first and second extended portions 20b and 20c refer to portions outside the coinciding parts.

As illustrated in FIG. 2, the coil 20 has, as viewed in the direction of the axis AX, a top surface facing portion 21 opposite the top surface 18, a first end surface facing portion 22 opposite the first end surface 15, a first outer electrode facing portion 23 opposite the first outer electrode 30, a bottom surface facing portion 24 opposite the bottom surface 17, a second outer electrode facing portion 25 opposite the second outer electrode 40, and a second end surface facing portion 26 opposite the second end surface 16.

The top surface facing portion 21 faces the top surface 18 without the first outer electrode 30, the second outer electrode 40, and the coil 20 therebetween. The first end surface facing portion 22 faces the first end surface 15 without the first outer electrode 30, the second outer electrode 40, and the coil 20 therebetween. The first outer electrode facing portion 23 faces the first outer electrode 30 without the second outer electrode 40 and the coil 20 therebetween. The bottom surface facing portion 24 faces the bottom surface 17 without the first outer electrode 30, the second outer electrode 40, and the coil 20 therebetween. The second outer electrode facing portion 25 faces the second outer electrode 40 without the first outer electrode 30 and the coil 20 therebetween. The second end surface facing portion 26 faces the second end surface 16 without the first outer electrode 30, the second outer electrode 40, and the coil 20 therebetween.

The boundaries between the top surface facing portion 21, the first end surface facing portion 22, the first outer electrode facing portion 23, the bottom surface facing portion 24, the second outer electrode facing portion 25, and the second end surface facing portion 26 are portions opposite the boundaries between the surfaces 15, 16, 17, and 18 and the outer electrodes 30 and 40, and specifically, they are each indicated by a dot-and-dash line in FIG. 2. In particular, rounded corners of the coil 20 adjacent to the top surface 18 are included in the top surface facing portion 21.

The top surface facing portion 21, the first end surface facing portion 22, the first outer electrode facing portion 23, the bottom surface facing portion 24, the second outer electrode facing portion 25, and the second end surface facing portion 26 are annularly arranged in sequence. In the present embodiment, the top surface facing portion 21, the first end surface facing portion 22, the first outer electrode facing portion 23, the bottom surface facing portion 24, the second outer electrode facing portion 25, and the second end surface facing portion 26 are arranged counterclockwise.

The outermost circumferential shape of the top surface facing portion 21 includes a linear portion parallel to the top surface 18, and curved portions connected to both ends of the linear portion and protruding outward in the radial direction of the coil 20. The outermost circumferential shape of the first end surface facing portion 22 includes a linear portion parallel to the first end surface 15. The outermost circumferential shape of the first outer electrode facing portion 23 includes a linear portion parallel to the first end surface portion 31 of the first outer electrode 30, and a curved portion connected to the linear portion, protruding outward in the radial direction of the coil 20, and partially parallel to the first bottom surface portion 32 of the first outer electrode 30.

The outermost circumferential shape of the bottom surface facing portion 24 includes a linear portion parallel to the bottom surface 17, first curved portions connected to both ends of the linear portion and protruding outward in the radial direction of the coil 20, and second curved portions connected to the first curved portions at both ends and protruding inward in the radial direction of the coil 20. The outermost circumferential shape of the second outer electrode facing portion 25 includes a linear portion parallel to the second end surface portion 41 of the second outer electrode 40, and a curved portion connected to the linear portion, protruding outward in the radial direction of the coil 20, and partially parallel to the second bottom surface portion 42 of the second outer electrode 40. The outermost circumferential shape of the second end surface facing portion 26 includes a linear portion parallel to the second end surface 16.

The outermost circumferential shape of the top surface facing portion 21 is not necessarily required to include the linear portion parallel to the top surface 18, the outermost circumferential shape of the first end surface facing portion 22 is not necessarily required to include the linear portion parallel to the first end surface 15, the outermost circumferential shape of the first outer electrode facing portion 23 is not necessarily required to include the linear portions parallel to the first end surface portion 31 and the first bottom surface portion 32 of the first outer electrode 30, the outermost circumferential shape of the bottom surface facing portion 24 is not necessarily required to include the linear portion parallel to the bottom surface 17, the outermost circumferential shape of the second outer electrode facing portion 25 is not necessarily required to include the linear portions parallel to the second end surface portion 41 and the second bottom surface portion 42 of the second outer electrode 40, and the outermost circumferential shape of the second end surface facing portion 26 is not necessarily required to include the linear portion parallel to the second end surface 16.

As viewed in the direction of the axis AX, the coil 20 is bilaterally symmetrical with respect to a straight line passing through the axis AX of the coil 20 and parallel to the Z direction. This can reduce variation in characteristics of the inductor component 1.

Specifically, the first end surface facing portion 22 and the second end surface facing portion 26 are bilaterally symmetrical with respect to a straight line passing through the axis AX of the coil 20 and parallel to the Z direction. The first outer electrode facing portion 23 and the second outer electrode facing portion 25 are bilaterally symmetrical with respect to a straight line passing through the axis AX of the coil 20 and parallel to the Z direction. The top surface facing portion 21 is bilaterally symmetrical with respect to a straight line passing through the axis AX of the coil 20 and parallel to the Z direction. The bottom surface facing portion 24 is bilaterally symmetrical with respect to a straight line passing through the axis AX of the coil 20 and parallel to the Z direction.

As illustrated in FIG. 3A and FIG. 3B, the coil 20 includes a plurality of coil wiring layers 501 to 510 stacked along the axis AX, and a plurality of via wiring layers 601 to 609 each disposed between coil wiring layers adjacent in the direction of the axis AX and configured to connect the coil wiring layers adjacent in the direction of the axis AX. The plurality of coil wiring layers 501 to 510 are each disposed on a corresponding one of the insulating layers 11, and the plurality of via wiring layers 601 to 609 are each disposed in a corresponding one of the insulating layers 11. Note that the insulating layers 11 in the same layers as the via wiring layers 601 to 609 are not illustrated in FIG. 3A and FIG. 3B.

The plurality of coil wiring layers 501 to 510 are each wound along a plane to form a helix while being electrically connected in series. The plurality of coil wiring layers 501 to 510 are each formed by being wound along the XZ plane (principal surface of the insulating layer 11) orthogonal to the direction of the axis AX (Y direction). The coil wiring layers 501 to 510 each have a constant width along the direction in which they extend.

The plurality of via wiring layers 601 to 609 penetrate the insulating layers 11 in the thickness direction (Y direction). As viewed in the direction of the axis AX, the plurality of via wiring layers 601 to 609 extend along the helical direction of the coil 20. The coil wiring layers adjacent in the stacking direction are electrically connected in series, with the via wiring layer therebetween.

Specifically, the first coil wiring layer 501, the second coil wiring layer 502, the third coil wiring layer 503, the fourth coil wiring layer 504, the fifth coil wiring layer 505, the sixth coil wiring layer 506, the seventh coil wiring layer 507, the eighth coil wiring layer 508, the ninth coil wiring layer 509, and the tenth coil wiring layer 510 are stacked in sequence along the Y direction. An end portion of the first coil wiring layer 501 is connected to the first outer electrode conductor layer 33 of the first outer electrode 30. An end portion of the tenth coil wiring layer 510 is connected to the second outer electrode conductor layer 43 of the second outer electrode 40.

The number of turns of each of the fifth coil wiring layer 505 and the sixth coil wiring layer 506 is less than one. The number of turns of each of the first to fourth coil wiring layers 501 to 504 and the seventh to tenth coil wiring layers 507 to 510 is greater than or equal to one. Since this can increase the number of turns of the coil 20 while reducing the size of the coil 20 in the direction of the axis AX, both miniaturization and an improved inductance value can be achieved. It is simply required that the number of turns of at least one of all the coil wiring layers be greater than or equal to one, so that both miniaturization and an improved inductance value can be achieved. The number of turns of every coil wiring layer may be less than one.

The first via wiring layer 601, the second via wiring layer 602, the third via wiring layer 603, the fourth via wiring layer 604, the fifth via wiring layer 605, the sixth via wiring layer 606, the seventh via wiring layer 607, the eighth via wiring layer 608, and the ninth via wiring layer 609 are stacked in sequence along the Y direction. All the via wiring layers 601 to 609 are formed in a linear shape. The via wiring layers 601 to 609 each have a constant width along the direction in which they extend.

The first via wiring layer 601 is disposed between the first coil wiring layer 501 and the second coil wiring layer 502, and connects an end portion of the first coil wiring layer 501 to an end portion of the second coil wiring layer 502. The second via wiring layer 602 is disposed between the second coil wiring layer 502 and the third coil wiring layer 503, and connects the other end portion of the second coil wiring layer 502 to an end portion of the third coil wiring layer 503. The third via wiring layer 603 is disposed between the third coil wiring layer 503 and the fourth coil wiring layer 504, and connects the other end portion of the third coil wiring layer 503 to an end portion of the fourth coil wiring layer 504. The fourth via wiring layer 604 is disposed between the fourth coil wiring layer 504 and the fifth coil wiring layer 505, and connects the other end portion of the fourth coil wiring layer 504 to an end portion of the fifth coil wiring layer 505. The fifth via wiring layer 605 is disposed between the fifth coil wiring layer 505 and the sixth coil wiring layer 506, and connects the other end portion of the fifth coil wiring layer 505 to an end portion of the sixth coil wiring layer 506.

The sixth via wiring layer 606 is disposed between the sixth coil wiring layer 506 and the seventh coil wiring layer 507, and connects the other end portion of the sixth coil wiring layer 506 to an end portion of the seventh coil wiring layer 507. The seventh via wiring layer 607 is disposed between the seventh coil wiring layer 507 and the eighth coil wiring layer 508, and connects the other end portion of the seventh coil wiring layer 507 to an end portion of the eighth coil wiring layer 508. The eighth via wiring layer 608 is disposed between the eighth coil wiring layer 508 and the ninth coil wiring layer 509, and connects the other end portion of the eighth coil wiring layer 508 to an end portion of the ninth coil wiring layer 509. The ninth via wiring layer 609 is disposed between the ninth coil wiring layer 509 and the tenth coil wiring layer 510, and connects the other end portion of the ninth coil wiring layer 509 to an end portion of the tenth coil wiring layer 510.

As illustrated in FIG. 2, FIG. 3A, and FIG. 3B, the bottom surface facing portion 24 does not include any of the via wiring layers 601 to 609 but includes the coil wiring layers 501 to 510. Specifically, the bottom surface facing portion 24 includes part of each of the coil wiring layers 501 to 510.

In the configuration described above, the bottom surface facing portion 24 does not include any of the via wiring layers 601 to 609 but includes the coil wiring layers 501 to 510. Therefore, when the inductor component 1 is mounted on a mount board (not illustrated), with the bottom surface 17 of the base body 10 facing the mount board, none of the via wiring layers 601 to 609 is present in the bottom surface facing portion 24 of the coil 20 close to the mount board. The present inventors found here that during mounting of the inductor component 1, for example, thermal stress from solder or bending stress from the mount board was applied particularly to a portion close to part of the inductor component 1 fastened to the mount board, that is, applied particularly to the bottom surface facing portion 24 close to the mount board.

Therefore, even when thermal stress or bending stress during mounting causes significant stress on the bottom surface facing portion 24, the occurrence of delamination between the via wiring layers 601 to 609 and the coil wiring layers 501 to 510 can be reduced, as the via wiring layers 601 to 609 are present outside the bottom surface facing portion 24 of the coil 20. Accordingly, even in recent circumstances where efforts have been made to make the inductor component 1 smaller, the occurrence of delamination between the via wiring layers 601 to 609 and the coil wiring layers 501 to 510 can be reduced. Note that the bottom surface facing portion 24 is not necessarily required to include part of every one of the coil wiring layers 501 to 510, and is simply required to include part of at least one of the coil wiring layers.

As illustrated in FIG. 2, FIG. 3A, and FIG. 3B, each of the via wiring layers 601 to 609 is present in at least one of the top surface facing portion 21, the first end surface facing portion 22, the first outer electrode facing portion 23, the second outer electrode facing portion 25, and the second end surface facing portion 26.

Specifically, the first to third via wiring layers 601 to 603, the fifth via wiring layer 605, and the seventh to ninth via wiring layers 607 to 609 are present in the top surface facing portion 21. As viewed in the direction of the axis AX, the first to third via wiring layers 601 to 603, the fifth via wiring layer 605, and the seventh to ninth via wiring layer 607 to 609 linearly extend in the direction parallel to the top surface 18. The sixth via wiring layer 606 is present in the first outer electrode facing portion 23. As viewed in the direction of the axis AX, the sixth via wiring layer 606 linearly extends in the direction parallel to the first end surface portion 31 of the first outer electrode 30. The fourth via wiring layer 604 is present in the second outer electrode facing portion 25. As viewed in the direction of the axis AX, the fourth via wiring layer 604 linearly extends in the direction parallel to the second end surface portion 41 of the second outer electrode 40.

In the configuration described above, none of the via wiring layers 601 to 609 is present in the bottom surface facing portion 24. Therefore, even when thermal stress or bending stress during mounting causes significant stress on the bottom surface facing portion 24, the occurrence of delamination between the via wiring layers 601 to 609 and the coil wiring layers 501 to 510 can be reduced.

Preferably, as viewed in the direction of the axis AX, all the via wiring layers 601 to 609 linearly extend and are connected to linear portions of the coil wiring layers 501 to 510. That is, as viewed in the direction of the axis AX, all the via wiring layers 601 to 609 are distant from corners of the coil 20.

In the configuration described above, the corners of the coil 20 are susceptible to stress as viewed in the direction of the axis AX. However, since the via wiring layers 601 to 609 are not disposed at the corners of the coil 20, the occurrence of delamination between the via wiring layers 601 to 609 and the coil wiring layers 501 to 510 can be reduced.

It is simply required, as viewed in the direction of the axis AX, that at least one of the via wiring layers 601 to 609 linearly extend and be connected to the linear portions of coil wiring layers adjacent in the direction of the axis AX.

Here, as viewed in the direction of the axis AX, at least one of the via wiring layers 601 to 609 is preferably parallel to one of the top surface 18, the first end surface 15, and the second end surface 16. This can increase the inside diameter of the coil 20 and improve the inductance value.

Preferably, the bottom surface facing portion 24 is wound once, as viewed in the direction of the axis AX. That is, as viewed in the direction of the axis AX, the number of lines of the bottom surface facing portion 24 in the radial direction is one. Specifically, in the bottom surface facing portion 24, all the coil wiring layers 501 to 510 coincide, as viewed in the direction of the axis AX.

In the configuration described above, the bottom surface facing portion 24 is wound once, as viewed in the direction of the axis AX. The configuration of the bottom surface facing portion 24 can thus be simplified. Therefore, even when thermal stress or bending stress during mounting causes significant stress on the bottom surface facing portion 24, the influence of stress on the coil characteristics can be reduced.

Preferably, the top surface facing portion 21 is wound twice, as viewed in the direction of the axis AX. That is, as viewed in the direction of the axis AX, the number of lines of the top surface facing portion 21 in the radial direction is two, and the top surface facing portion 21 has a first line 211 on the radially inner side and a second line 212 on the radially outer side. The first line 211 and the second line 212 are parallel to each other. Specifically, in the top surface facing portion 21, as viewed in the direction of the axis AX, the first to fourth coil wiring layers 501 to 504 and the seventh to tenth coil wiring layers 507 to 510 each have portions running side by side in the radial direction.

In the configuration described above, the top surface facing portion 21 is wound twice, as viewed in the direction of the axis AX. It is thus possible to increase the number of turns of the coil 20 while reducing the size of the coil 20 in the direction of the axis AX. Therefore, both miniaturization and an improved inductance value can be achieved.

Preferably, the first via wiring layer 601, the third via wiring layer 603, the seventh via wiring layer 607, and the ninth via wiring layer 609 are present on the first line 211 on the radially inner side of the top surface facing portion 21, as viewed in the direction of the axis AX. The first via wiring layer 601, the third via wiring layer 603, the seventh via wiring layer 607, and the ninth via wiring layer 609 coincide, as viewed in the direction of the axis AX. Preferably, the second via wiring layer 602, the fifth via wiring layer 605, and the eighth via wiring layer 608 are present on the second line 212 on the radially outer side of the top surface facing portion 21, as viewed in the direction of the axis AX. The second via wiring layer 602, the fifth via wiring layer 605, and the eighth via wiring layer 608 coincide, as viewed in the direction of the axis AX.

Preferably, the first outer electrode facing portion 23 is wound twice, as viewed in the direction of the axis AX. That is, as viewed in the direction of the axis AX, the number of lines of the first outer electrode facing portion 23 in the radial direction is two, and the first outer electrode facing portion 23 has a first line 231 on the radially inner side and a second line 232 on the radially outer side. The first line 231 and the second line 232 are parallel to each other. Specifically, in the first outer electrode facing portion 23, as viewed in the direction of the axis AX, the seventh coil wiring layer 507 has portions running side by side in the radial direction.

In the configuration described above, the first outer electrode facing portion 23 is wound twice, as viewed in the direction of the axis AX. It is thus possible to increase the number of turns of the coil 20 while reducing the size of the coil 20 in the direction of the axis AX. Therefore, both miniaturization and an improved inductance value can be achieved.

Preferably, the sixth via wiring layer 606 is present on the second line 232 on the radially outer side of the first outer electrode facing portion 23, as viewed in the direction of the axis AX.

Preferably, the second outer electrode facing portion 25 is wound twice, as viewed in the direction of the axis AX. That is, as viewed in the direction of the axis AX, the number of lines of the second outer electrode facing portion 25 in the radial direction is two, and the second outer electrode facing portion 25 has a first line 251 on the radially inner side and a second line 252 on the radially outer side. The first line 251 and the second line 252 are parallel to each other. Specifically, in the second outer electrode facing portion 25, as viewed in the direction of the axis AX, the fourth coil wiring layer 504 has portions running side by side in the radial direction.

In the configuration described above, the second outer electrode facing portion 25 is wound twice, as viewed in the direction of the axis AX. It is thus possible to increase the number of turns of the coil 20 while reducing the size of the coil 20 in the direction of the axis AX. Therefore, both miniaturization and an improved inductance value can be achieved.

Preferably, the fourth via wiring layer 604 is present on the second line 252 on the radially outer side of the second outer electrode facing portion 25, as viewed in the direction of the axis.

Preferably, the first end surface facing portion 22 is wound once, as viewed in the direction of the axis AX. That is, as viewed in the direction of the axis AX, the number of lines of the first end surface facing portion 22 in the radial direction is one. Preferably, the second end surface facing portion 26 is wound once, as viewed in the direction of the axis AX. That is, as viewed in the direction of the axis AX, the number of lines of the second end surface facing portion 26 in the radial direction is one.

A method for manufacturing the inductor component 1 will now be described.

As illustrated in FIG. 3A and FIG. 3B, the inductor component 1 is manufactured by alternately stacking the first to tenth coil wiring layers 501 to 510 and the first to ninth via wiring layers 601 to 609 together with the insulating layers 11 in the direction from top to bottom in the drawings. The coil wiring layers 501 to 510 are produced, for example, by screen printing on the insulating layers 11. The via wiring layers 601 to 609 are produced, for example, by screen printing in openings formed, for example, by a photolithographic or laser technique in the insulating layers 11.

### Second Embodiment

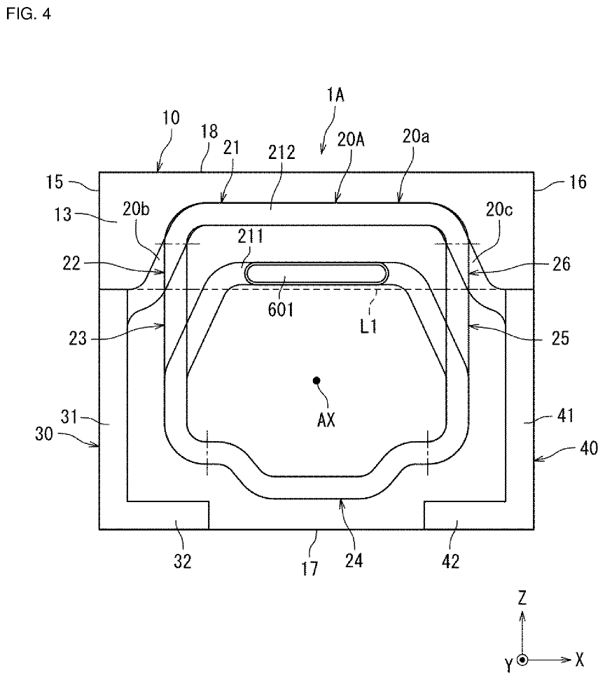

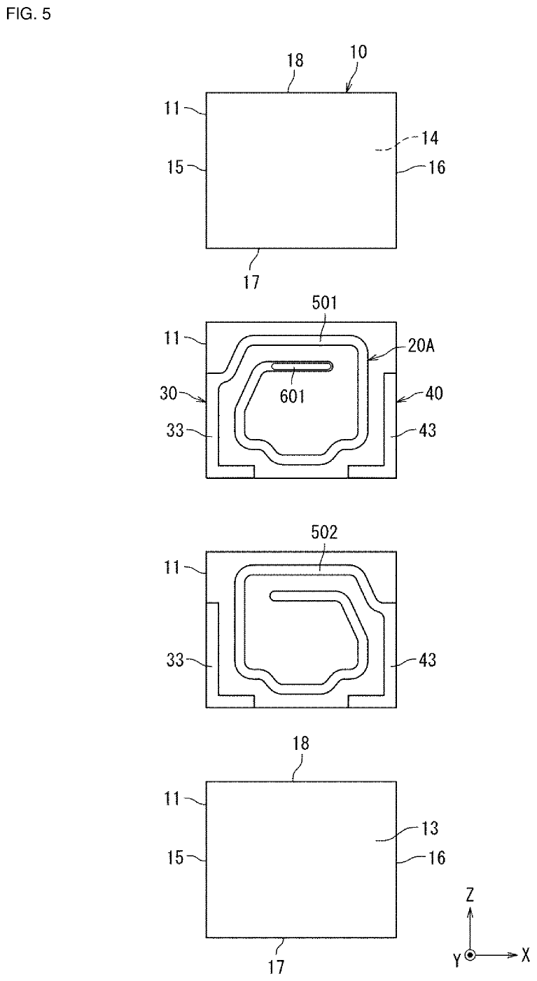

FIG. 4 is a transparent front view of a second embodiment of the inductor component, as viewed from the first side surface of the inductor component. FIG. 5 is an exploded plan view of the inductor component. The second embodiment differs from the first embodiment in the number of via wiring layers and coil wiring layers and the positions of the via wiring layers. These differences will now be described. The other configurations are the same as those of the first embodiment and their description will be omitted by assigning the same reference numerals as those in the first embodiment.

As illustrated in FIG. 4 and FIG. 5, in an inductor component 1A of the second embodiment, a coil 20A includes two coil wiring layers 501 and 502 and one via wiring layer 601. Specifically, the first coil wiring layer 501, the first via wiring layer 601, and the second coil wiring layer 502 are stacked in sequence along the Y direction.

An end portion of the first coil wiring layer 501 is connected to the first outer electrode conductor layer 33 of the first outer electrode 30. An end portion of the second coil wiring layer 502 is connected to the second outer electrode conductor layer 43 of the second outer electrode 40. The first via wiring layer 601 is disposed between the first coil wiring layer 501 and the second coil wiring layer 502, and connects the other end portion of the first coil wiring layer 501 to the other end portion of the second coil wiring layer 502.

The entire via wiring layer 601 is present in the top surface facing portion 21. In the configuration described above, the entire via wiring layer 601 can be disposed in the top surface facing portion 21, which is farthest in the coil 20A from the mount board. This can further reduce the occurrence of delamination between the via wiring layer 601 and the coil wiring layers 501 and 502.

As viewed in the direction of the axis AX, the entire via wiring layer 601 is disposed closer to the top surface 18 than the first outer electrode 30 and the second outer electrode 40 are. Specifically, as viewed in the direction of the axis AX, the entire via wiring layer 601 is disposed on the upper side of an upper end line L1 that connects an upper end of the first end surface portion 31 in the Z direction to an upper end of the second end surface portion 41 in the Z direction. With this configuration, even when the inductor component 1A is subjected to thermal stress or bending stress from the side of the first outer electrode 30 and the second outer electrode 40 while being mounted, the amount of stress applied to the entire via wiring layer 601 can be reduced. This can further reduce the occurrence of delamination between the via wiring layer 601 and the coil wiring layers 501 and 502. Note that the upper end of the first end surface portion 31 in the Z direction and the upper end of the second end surface portion 41 in the Z direction are upper ends of the first end surface portion and the second end surface portion that are in the same layer as the via wiring layer 601.

Preferably, the bottom surface facing portion 24 is wound once, as viewed in the direction of the axis AX. That is, as viewed in the direction of the axis AX, the number of lines of the bottom surface facing portion 24 in the radial direction is one. Specifically, in the bottom surface facing portion 24, the coil wiring layers 501 and 502 coincide, as viewed in the direction of the axis AX.

In the configuration described above, the bottom surface facing portion 24 is wound once, as viewed in the direction of the axis AX. The configuration of the bottom surface facing portion 24 can thus be simplified. Therefore, even when thermal stress or bending stress during mounting causes significant stress on the bottom surface facing portion 24, the influence of stress on the coil characteristics can be reduced.

Preferably, the top surface facing portion 21 is wound twice, as viewed in the direction of the axis AX. That is, as viewed in the direction of the axis AX, the number of lines of the top surface facing portion 21 in the radial direction is two, and the top surface facing portion 21 has the first line 211 on the radially inner side and the second line 212 on the radially outer side. The first line 211 and the second line 212 are parallel to each other. Specifically, in the top surface facing portion 21, as viewed in the direction of the axis AX, the first and second coil wiring layers 501 and 502 each have portions running side by side in the radial direction.

In the configuration described above, the top surface facing portion 21 is wound twice, as viewed in the direction of the axis AX. It is thus possible to increase the number of turns of the coil 20 while reducing the size of the coil 20 in the direction of the axis AX. Therefore, both miniaturization and an improved inductance value can be achieved.

Preferably, the first via wiring layer 601 is present on the first line 211 on the radially inner side of the top surface facing portion 21, as viewed in the direction of the axis AX.

Preferably, the first outer electrode facing portion 23 is wound once, as viewed in the direction of the axis AX. That is, as viewed in the direction of the axis AX, the number of lines of the first outer electrode facing portion 23 in the radial direction is one. Preferably, the second outer electrode facing portion 25 is wound once, as viewed in the direction of the axis AX. That is, as viewed in the direction of the axis AX, the number of lines of the second outer electrode facing portion 25 in the radial direction is one.

Preferably, the first end surface facing portion 22 is wound once, as viewed in the direction of the axis AX. That is, as viewed in the direction of the axis AX, the number of lines of the first end surface facing portion 22 in the radial direction is one. Preferably, the second end surface facing portion 26 is wound once, as viewed in the direction of the axis AX. That is, as viewed in the direction of the axis AX, the number of lines of the second end surface facing portion 26 in the radial direction is one.

### Third Embodiment

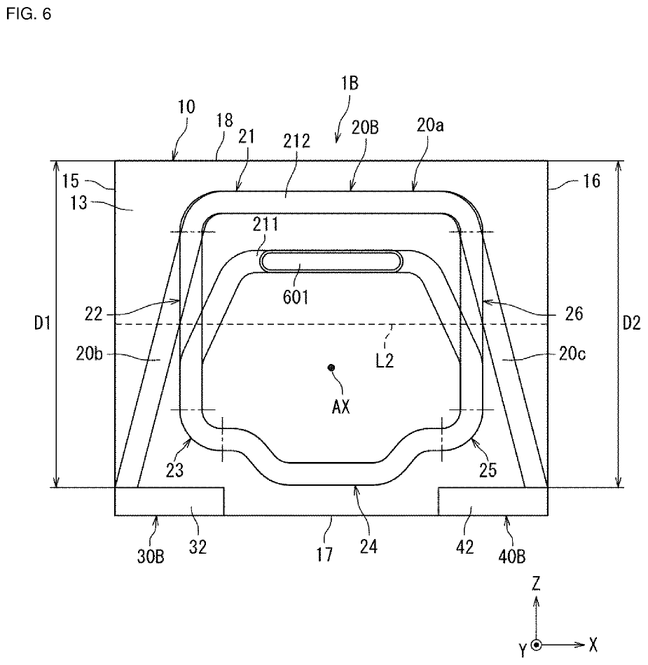

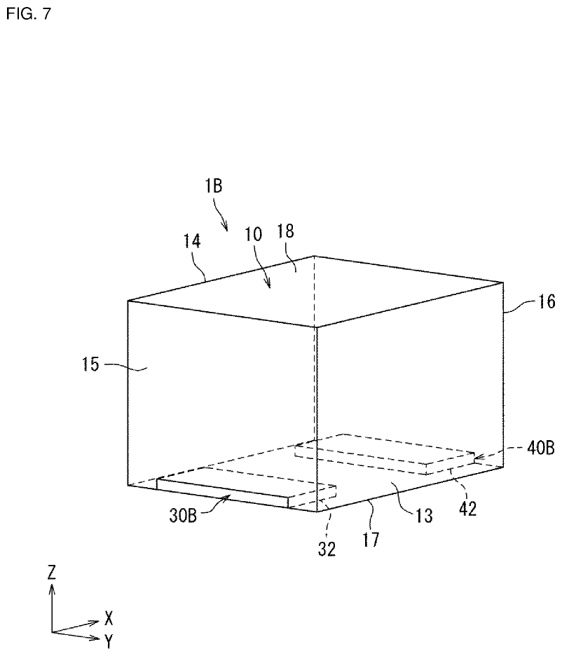

FIG. 6 is a transparent front view of a third embodiment of the inductor component, as viewed from the first side surface of the inductor component. FIG. 7 is a perspective view of the third embodiment of the inductor component. The third embodiment differs from the second embodiment in the configurations of the coil, the first outer electrode, and the second outer electrode. These differences will now be described. The other configurations are the same as those of the second embodiment and their description will be omitted by assigning the same reference numerals as those in the second embodiment.

As illustrated in FIG. 6 and FIG. 7, in an inductor component 1B of the third embodiment, a first outer electrode 30B is disposed only on the bottom surface 17. That is, the first outer electrode 30B is constituted by the first bottom surface portion 32. A second outer electrode 40B is disposed only on the bottom surface 17. That is, the second outer electrode 40B is constituted by the second bottom surface portion 42.

Like the coil 20A of the second embodiment, a coil 20B includes two coil wiring layers 501 and 502 and one via wiring layer 601. In the coil 20B, unlike the coil 20A of the second embodiment, the first end surface facing portion 22 and the second end surface facing portion 26 are long in the direction in which they extend, and the first outer electrode facing portion 23 and the second outer electrode facing portion 25 are short in the direction in which they extend.

As viewed in the direction of the axis AX, the entire via wiring layer 601 is disposed closer to the top surface 18 than a first straight line is, and disposed closer to the top surface 18 than a second straight line is. The first straight line is a straight line parallel to the bottom surface 17 and located at half the distance (referred to as a first distance D1) between the first outer electrode 30B and the top surface 18 in the direction from the first outer electrode 30B toward the top surface 18. The second straight line is a straight line parallel to the bottom surface 17 and located at half the distance (referred to as a second distance D2) between the second outer electrode 40B and the top surface 18 in the direction from the second outer electrode 40B toward the top surface 18. The first distance D1 is the shortest distance between the first outer electrode 30B and the top surface 18, and the second distance D2 is the shortest distance between the second outer electrode 40B and the top surface 18.

In the present embodiment, the first distance D1 and the second distance D2 are equal. The first straight line and the second straight line are the same straight line defined as a reference line L2. The distance between the first outer electrode 30B and the reference line L2 (first straight line) is half the first distance D1. The distance between the second outer electrode 40B and the reference line L2 (second straight line) is half the second distance D2.

In the configuration described above, the entire via wiring layer 601 is disposed closer to the top surface 18 than the first straight line and the second straight line are. Therefore, even when the inductor component 1B is subjected to thermal stress or bending stress from the side of the first outer electrode 30B and the second outer electrode 40B while being mounted, the amount of stress applied to the entire via wiring layer 601 can be reduced. This can further reduce the occurrence of delamination between the via wiring layer 601 and the coil wiring layers 501 and 502. Note that the first distance D1 and the second distance D2 are the distance between the top surface 18 and the first outer electrode 30B and the second outer electrode 40B that are in the same layer as the via wiring layer 601.

The present disclosure is not limited to the embodiments described above, and design changes can be made without departing from the scope of the present disclosure. For example, features of the first to third embodiments may be variously combined. The number of coil wiring layers may be either increased or decreased, and the number of via wiring layers may be either increased or decreased.

The top surface facing portion, the first end surface facing portion, the first outer electrode facing portion, the bottom surface facing portion, the second outer electrode facing portion, and the second end surface facing portion are simply required to be wound once, twice, or more.

The shape of the via wiring layer may be circular instead of linear, as viewed in the direction of the axis. In this case, the end portion of the coil wiring layer connected to the circular via wiring layer forms a circular pad portion, as viewed in the direction of the axis, and the diameter of the circular pad portion is greater than the line width of an intermediate portion of the coil wiring layer.

The present disclosure includes the following aspects.

<1>An inductor component includes a base body, a coil disposed inside the base body and helically wound along an axis, and a first outer electrode and a second outer electrode disposed in the base body and electrically connected to the coil. The base body includes a first end surface and a second end surface opposite each other, a first side surface and a second side surface opposite each other, a bottom surface connected between the first end surface and the second end surface and between the first side surface and the second side surface, and a top surface opposite the bottom surface. The first outer electrode and the second outer electrode are disposed at least on the bottom surface. The axis is parallel to the bottom surface and intersects with the first side surface and the second side surface. The coil includes a plurality of coil wiring layers stacked along the axis, and a plurality of via wiring layers each configured to connect adjacent ones of the coil wiring layers in an axial direction, which is a direction of the axis. The coil includes a bottom surface facing portion facing the bottom surface, as viewed in the axial direction, without the first outer electrode, the second outer electrode, and the coil therebetween. The bottom surface facing portion does not include the via wiring layer, but includes the coil wiring layer.

<2>In the inductor component according to <1>, the coil further includes, as viewed in the axial direction, a top surface facing portion facing the top surface, without the first outer electrode, the second outer electrode, and the coil therebetween, a first end surface facing portion facing the first end surface, without the first outer electrode, the second outer electrode, and the coil therebetween, a first outer electrode facing portion facing the first outer electrode, without the second outer electrode and the coil therebetween, a second outer electrode facing portion facing the second outer electrode, without the first outer electrode and the coil therebetween, and a second end surface facing portion facing the second end surface, without the first outer electrode, the second outer electrode, and the coil therebetween. Each of the via wiring layers is present in at least one of the top surface facing portion, the first end surface facing portion, the first outer electrode facing portion, the second outer electrode facing portion, and the second end surface facing portion.

<3>In the inductor component according to <2>, all the via wiring layers are present in the top surface facing portion.

<4>In the inductor component according to any one of <1>to <3>, the first outer electrode extends from the bottom surface to the first end surface, and the second outer electrode extends from the bottom surface to the second end surface.

<5>In the inductor component according to any one of <1>to <3>, the first outer electrode extends from the bottom surface to the first end surface, and the second outer electrode extends from the bottom surface to the second end surface. As viewed in the axial direction, all the via wiring layers are disposed closer to the top surface than the first outer electrode and the second outer electrode are.

<6>In the inductor component according to any one of <1>to <3>, the first outer electrode is disposed only on the bottom surface, and the second outer electrode is disposed only on the bottom surface. As viewed in the axial direction, all the via wiring layers are disposed closer to the top surface than a position at half a distance between the first outer electrode and the top surface in a direction from the first outer electrode toward the top surface is, and are disposed closer to the top surface than a position at half a distance between the second outer electrode and the top surface in a direction from the second outer electrode toward the top surface is.

<7>In the inductor component according to any one of <1>to <6>, the coil wiring layers are each wound along a plane orthogonal to the axis, and the number of turns of at least one of all the coil wiring layers is greater than or equal to one.

<8>In the inductor component according to any one of <1>to <7>, the bottom surface facing portion is wound once, as viewed in the axial direction.

<9>The inductor component according to any one of <1>to <8>, at least one of the via wiring layers linearly extends, as viewed in the axial direction, and is connected to linear portions of adjacent ones of the coil wiring layers in the axial direction.

<10>In the inductor component according to <9>, at least one of the via wiring layers is parallel to one of the top surface, the first end surface, and the second end surface, as viewed in the axial direction.

What is claimed is:

1. An inductor component comprising:
a base body including a first end surface and a second end surface opposite each other, a first side surface and a second side surface opposite each other, a bottom surface connected between the first end surface and the second end surface and between the first side surface and the second side surface, and a top surface opposite the bottom surface;
a coil inside the base body and helically wound along an axis, and the axis being parallel to the bottom surface and intersecting with the first side surface and the second side surface; and
a first outer electrode and a second outer electrode in the base body and electrically connected to the coil, the first outer electrode and the second outer electrode being at least on the bottom surface,
wherein
the coil includes a plurality of coil wiring layers stacked along the axis, and a plurality of via wiring layers each configured to connect adjacent ones of the coil wiring layers in an axial direction, the axial direction being a direction of the axis;
the coil includes a bottom surface facing portion facing the bottom surface, as viewed in the axial direction, without interposing the first outer electrode, the second outer electrode, and the coil between the bottom surface facing portion and the bottom surface; and
the bottom surface facing portion includes the coil wiring layers, and the bottom surface facing portion does not include the via wiring layers.

2. The inductor component according to claim 1, wherein the coil further includes, as viewed in the axial direction,
a top surface facing portion facing the top surface, without the first outer electrode, the second outer electrode, and the coil therebetween,
a first end surface facing portion facing the first end surface, without the first outer electrode, the second outer electrode, and the coil therebetween,
a first outer electrode facing portion facing the first outer electrode, without the second outer electrode and the coil therebetween,
a second outer electrode facing portion facing the second outer electrode, without the first outer electrode and the coil therebetween, and
a second end surface facing portion facing the second end surface, without the first outer electrode, the second outer electrode, and the coil therebetween; and
all of the via wiring layers are present in at least one of the top surface facing portion, the first end surface facing portion, the first outer electrode facing portion, the second outer electrode facing portion, and the second end surface facing portion.

3. The inductor component according to claim 2, wherein
all the via wiring layers are present in the top surface facing portion.

4. The inductor component according to claim 1, wherein
the first outer electrode extends from the bottom surface to the first end surface, and
the second outer electrode extends from the bottom surface to the second end surface.

5. The inductor component according to claim 1, wherein
the first outer electrode extends from the bottom surface to the first end surface, and
the second outer electrode extends from the bottom surface to the second end surface; and
as viewed in the axial direction, all the via wiring layers are closer to the top surface than are the first outer electrode and the second outer electrode.

6. The inductor component according to claim 1, wherein
the first outer electrode is only on the bottom surface, and
the second outer electrode is only on the bottom surface; and
as viewed in the axial direction, all the via wiring layers are closer to the top surface than is a position at half a distance between the first outer electrode and the top surface in a direction from the first outer electrode toward the top surface, and are closer to the top surface than is a position at half a distance between the second outer electrode and the top surface in a direction from the second outer electrode toward the top surface.

7. The inductor component according to claim 1, wherein
the coil wiring layers are each wound along a plane orthogonal to the axis; and
a number of turns of at least one of all the coil wiring layers is greater than or equal to one.

8. The inductor component according to claim 1, wherein
the bottom surface facing portion is wound once, as viewed in the axial direction.

9. The inductor component according to claim 1, wherein
at least one of the via wiring layers linearly extends, as viewed in the axial direction, and is connected to linear portions of adjacent ones of the coil wiring layers in the axial direction.

10. The inductor component according to claim 9, wherein
at least one of the via wiring layers is parallel to one of the top surface, the first end surface, and the second end surface, as viewed in the axial direction.

11. The inductor component according to claim 2, wherein
the first outer electrode extends from the bottom surface to the first end surface, and the second outer electrode extends from the bottom surface to the second end surface.

12. The inductor component according to claim 2, wherein
the first outer electrode extends from the bottom surface to the first end surface, and
the second outer electrode extends from the bottom surface to the second end surface; and
as viewed in the axial direction, all the via wiring layers are closer to the top surface than are the first outer electrode and the second outer electrode.

13. The inductor component according to claim 2, wherein
the first outer electrode is only on the bottom surface, and
the second outer electrode is only on the bottom surface; and
as viewed in the axial direction, all the via wiring layers are closer to the top surface than is a position at half a distance between the first outer electrode and the top surface in a direction from the first outer electrode toward the top surface, and are closer to the top surface than is a position at half a distance between the second outer electrode and the top surface in a direction from the second outer electrode toward the top surface.

14. The inductor component according to claim 2, wherein
the coil wiring layers are each wound along a plane orthogonal to the axis; and
a number of turns of at least one of all the coil wiring layers is greater than or equal to one.

15. The inductor component according to claim 2, wherein
the bottom surface facing portion is wound once, as viewed in the axial direction.

16. The inductor component according to claim 2, wherein
at least one of the via wiring layers linearly extends, as viewed in the axial direction, and is connected to linear portions of adjacent ones of the coil wiring layers in the axial direction.

17. The inductor component according to claim 16, wherein
at least one of the via wiring layers is parallel to one of the top surface, the first end surface, and the second end surface, as viewed in the axial direction.
